(19) United States
(12) Patent Application Publication
(10) Pub. No.: US 2017/0135137 A1
(43) Pub. Date: May 11, 2017

(54) AGGREGATED WIRELESS DRIVER AND METHOD

(71) Applicant: Intel IP Corporation, Santa Clara, CA (US)

(72) Inventors: Shani Ben-Haim, Haifa (IL); Izoslav Slava Tchigevsky, Portland, OR (US); Michael Glik, Kfar Saba (IL); Tal Davidson, Petach Tikva (IL); Solomon Trainin, Haifa (IL)

(21) Appl. No.: 14/937,412

(22) Filed: Nov. 10, 2015

(51) Int. Cl. H04W 76/02; H04L 29/06

(52) U.S. Cl. CPC H04W 76/02; H04L 69/08; H04W 80/12

(57) ABSTRACT

A communication device and a communication method are provided. Interface devices of the communication device can be respectively configured to communicate with one or more other communication devices using a plurality of communication protocols. The communication device can include a memory that can store a plurality of radio interface drivers (RIDs) respectively associated with the plurality of interface devices. The memory can also store an aggregated wireless driver (AWD) forming an interface between an operating system (OS) of the communication device and the plurality of RIDs.

### BACKGROUND

### Field

Aspects described herein generally relate to wireless communication drivers, including wireless drivers for multiple wireless communication technologies.

### BRIEF DESCRIPTION OF THE DRAWINGS/FIGURES

The accompanying drawings, which are incorporated herein and form a part of the specification, illustrate the aspects of the present disclosure and, together with the description, further serve to explain the principles of the aspects and to enable a person skilled in the pertinent art to make and use the aspects.

FIG. 1 illustrates an example network environment.

FIG. 2 illustrates a base station according to an exemplary aspect of the present disclosure.

FIG. 3 illustrates a mobile device according to an exemplary aspect of the present disclosure.

FIG. 4 illustrates a communication system architecture according to an exemplary aspect of the present disclosure.

FIGS. 5A and 5B illustrate communication methods according to an exemplary aspect of the present disclosure.

FIG. 6 illustrates a discovery method according to an exemplary aspect of the present disclosure.

FIG. 7 illustrates a connection method according to an exemplary aspect of the present disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

By way of overview, a device driver (also referred to as a driver) is a computer program that facilitates communications between a hardware device and an application and/or operating system (OS) that uses the hardware device. The driver can provide a software interface to the hardware device that enables the operating system and/or other computer programs to access hardware functions associated with the hardware device. For example, the driver can include knowledge of the hardware device which allows the operating system and/or other computer programs to control and/or use the hardware device without requiring the OS or program to have an increased level of knowledge generally provided to the driver.

The driver can communicate with the hardware device through one or more communication systems (e.g., a bus) connected to the hardware device. In operation, when a program (e.g. a calling program) invokes a routine in the driver, the driver can issue one or more commands to the hardware device. The hardware device can send back data to the driver and the driver may initiate routines in the calling program. That is, the driver can function as a translator between the hardware device and the application and/or operating system using the hardware device.

Drivers can be hardware-dependent and/or operating-system specific. For example, a system can include a first driver associated with a first wireless communication device (e.g., Wi-Fi) and a second driver associated with a second wireless communication device (e.g., wireless gigabit). As discussed in exemplary aspects below, systems and methods can include an aggregated wireless driver (AWD) configured to aggregate the functionality and processing of a plurality of drivers associated with corresponding devices.

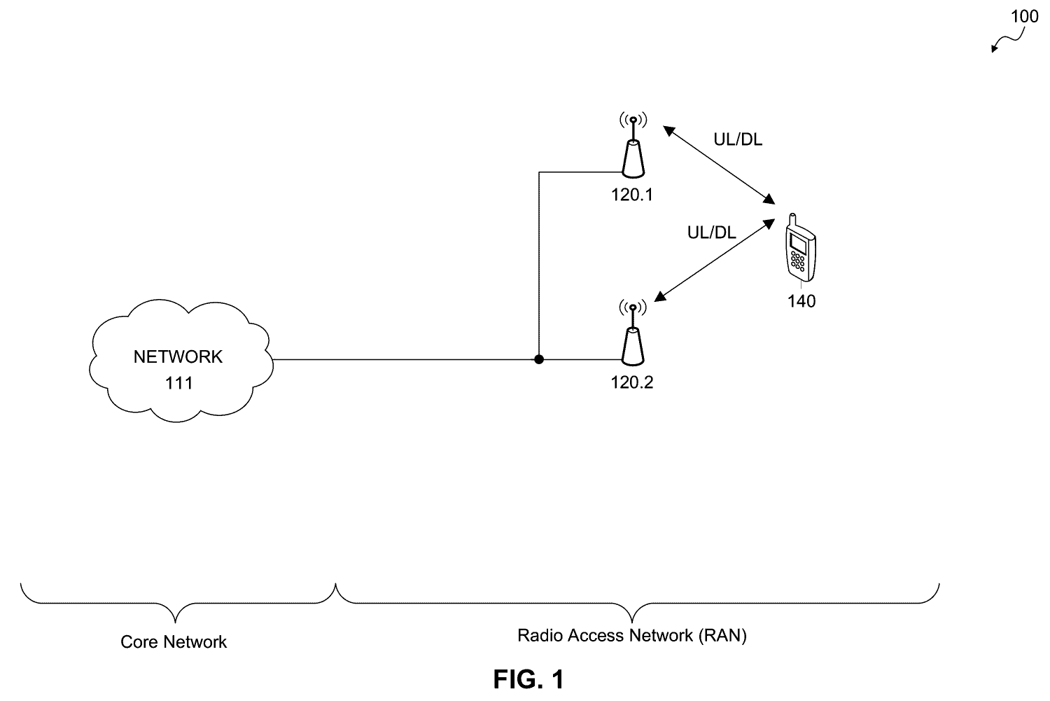

FIG. 1 illustrates an example communication environment 100 that includes a radio access network (RAN) and a core network. The RAN includes one or more base stations or access points (APs) 120 and one or more mobile devices 140. The base stations 120.1 and 120.2 can be configured for communications conforming to different wireless protocols or the same wireless protocol. Further, the base stations 120.1 and 120.2 can be embodied in the same device (e.g., same wireless router) or can be distinct devices served by the same network 111. The base stations 120 can be served by difference networks 111 or the same network 111 as illustrated.

The core network includes a backhaul communication network 111. In an exemplary aspect, the backhaul communication network 111 can include one or more well-known communication components—such as one or more network switches, one or more network gateways, and/or one or more servers. The backhaul communication network 111 can include one or more devices and/or components configured to exchange data with one or more other devices and/or components via one or more wired and/or wireless communications protocols. In exemplary aspects, the base stations 120 communicate with one or more service providers and/or one or more other base stations 120 via the backhaul communication network 111.

In an exemplary aspect, the backhaul communication network 111 is an internet protocol (IP) backhaul network. The number of base stations, mobile devices 140, and/or networks 111 are not limited to the exemplary quantities illustrated in FIG. 1, and the communication environment 100 can include any number of the various components as would be understood by one of ordinary skill in the relevant art(s).

In an exemplary aspect, the base station 120 and mobile device 140 each include processor circuitry that is configured to communicate via one or more wireless technologies. The mobile device 140 can be further configured to support co-existing wireless communications with the base station 120, and/or co-existing wireless communications with the base station 120 and one or more other base stations, where the base station 120 supports one or more wireless communications and the other base station supports one or more other wireless communications.

The mobile device 140 and the base station 120 can each include a transceiver configured to transmit and/or receive wireless communications via one or more wireless technologies within the communication environment 100. For example, the mobile device 140 receives signals on one or more downlink (DL) channels from the base stations 120, and transmits signals to the base stations 120 on one or more respective uplink (UL) channels.

Examples of the mobile device 140 include (but are not limited to) a mobile computing device—such as a laptop computer, a tablet computer, a mobile telephone or smartphone, a “phablet,” a personal digital assistant (PDA), and mobile media player; and a wearable computing device—such as a computerized wrist watch or “smart” watch, and computerized eyeglasses. In some aspects of the present disclosure, the mobile device 140 may be a stationary device, including, for example, a stationary computing device—such as a personal computer (PC), a desktop computer, a computerized kiosk, and an automotive/aeronautical/maritime in-dash computer terminal.

Examples of the base station 120 include (but are not limited to) a wireless access point, a wireless router, a wireless hotspot, a cell tower, or other wireless transceiver as would be understood by one of ordinary skill in the relevant arts.

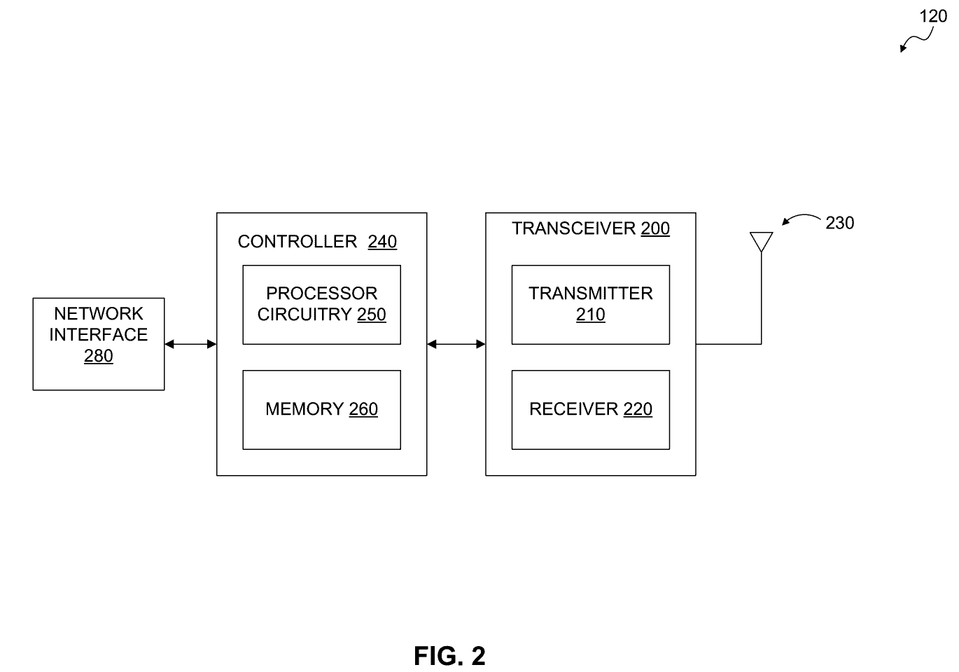

FIG. 2 illustrates the base station 120 according to an exemplary aspect of the present disclosure. For example, the base station 120 can include a transceiver 200 and a network interface 280, each communicatively coupled to controller 240.

The transceiver 200 includes processor circuitry that is configured to transmit and/or receive wireless communications via one or more wireless technologies within the communication environment 100. For example, the transceiver 200 can include one or more transmitters 210 and one or more receivers 220 that configured to transmit and receive wireless communications, respectively, via one or more antennas 230. Those skilled in the relevant art(s) will recognize that the transceiver 200 can also include (but is not limited to) a digital signal processer (DSP), modulator and/or demodulator, a digital-to-analog converter (DAC) and/or an analog-to-digital converter (ADC), and/or a frequency converter (including mixers, local oscillators, and filters) to provide some examples. Further, those skilled in the relevant art(s) will recognize that the antenna 230 may include an integer array of antennas, and that the antenna 230 may be capable of both transmitting and receiving wireless communication signals. For example, the base station 120 can be configured for wireless communication utilizing a Multiple-input Multiple-output (MIMO) configuration.

In an exemplary aspect, the transceiver 200 is configured for wireless communications conforming to, for example, one or more of the Institute of Electrical and Electronics Engineers' (IEEE) 802.11 protocols, including (but not limited to) Wi-Fi (e.g., 802.11g, 802.11n, 802.11ac), Wireless Gigabit (WiGig) as defined by IEEE 802.11ad, and/or one or more other 802.11 protocols as would be understood by one of ordinary skill in the art. The IEEE 802.11 protocols are incorporated herein by reference in their entirety. Further, those skilled in the relevant art(s) will understand that the transceiver 200 is not limited to IEEE 802.11 communication protocols, and can be configured for communications that conform to one or more other protocols.

The network interface 280 includes processor circuitry that is configured to transmit and/or receive communications via one or more wired technologies to/from the backhaul communication network 111. Those skilled in the relevant art(s) will recognize that the network interface 280 can also include (but is not limited to) a digital signal processer (DSP), modulator and/or demodulator, a digital-to-analog converter (DAC) and/or an analog-to-digital converter (ADC), and/or a frequency converter (including mixers, local oscillators, and filters) to provide some examples. Further, those skilled in the relevant art(s) will understand that the network interface 280 is not limited to wired communication technologies and can be configured for communications that conform to one or more well-known wireless technologies in addition to, or alternatively to, one or more well-known wired technologies.

The controller 240 can include processor circuitry 250 that is configured to carry out instructions to perform arithmetical, logical, and/or input/output (I/O) operations of the base station 120 and/or to control the operation of one or more components of the base station 120. The processor circuitry 250 can be configured control the operation of the transceiver 200—including, for example, transmitting and/or receiving of wireless communications via the transceiver 200, and/or perform one or more baseband processing functions (e.g., media access control (MAC), encoding/decoding, modulation/demodulation, data symbol mapping, error correction, etc.).

The controller 240 can further include a memory 260 that stores data and/or instructions, where when the instructions are executed by the processor circuitry 250, controls the processor circuitry 250 to perform the functions described herein. The memory 260 can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory 260 can be non-removable, removable, or a combination of both.

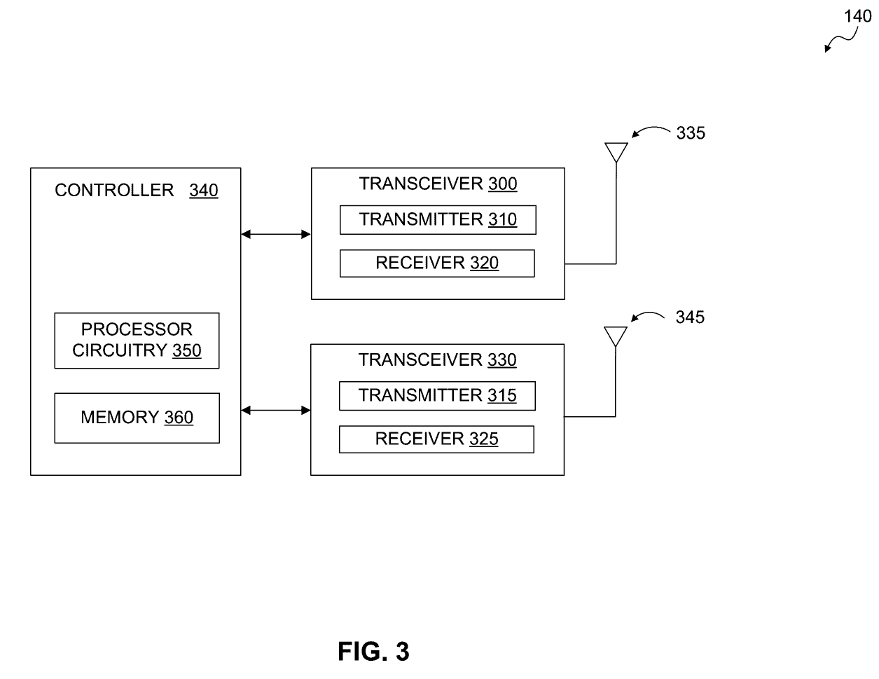

FIG. 3 illustrates the mobile device 140 according to an exemplary aspect of the present disclosure. The mobile device 140 can include controller 340 communicatively coupled to one or more transceivers configured to transmit and/or receive wireless communications via one or more wireless technologies within the communication environment 100. In an exemplary aspect, the mobile device 140 includes a transceiver 300 and a transceiver 330, but is not limited to two transceivers.

The transceiver 300 and transceiver 330 can each include processor circuitry that is configured for transmitting and/or receiving wireless communications conforming to one or more wireless protocols. For example, the transceiver 300 can include a transmitter 310 and receiver 320 that are configured for transmitting and receiving, for example, Wi-Fi communications, respectively, via one or more antennas 335. In this example, the transceiver 300 can be referred to as Wi-Fi transceiver 300. Those skilled in the relevant art(s) will understand that the transceiver 300 is not limited to 802.11 Wi-Fi communications, and can be configured for communications that conform to one or more other protocols in addition (or in the alternative) to the Wi-Fi communications.

The transceiver 330 can include a transmitter 315 and receiver 325 that are configured for transmitting and receiving, for example, WiGig communications, respectively, via one or more antennas 345. In this example, the transceiver 330 can be referred to as WiGig transceiver 330. Those skilled in the relevant art(s) will understand that the transceiver 300 is not limited to WiGig communications, and can be configured for communications that conform to one or more other protocols in addition (or in the alternative) to the WiGig communications.

In an exemplary aspect, the mobile device 140 can be configured to support co-existing wireless communications (e.g., Wi-Fi and WiGig) with one or more of the base stations 120.

In exemplary aspects, the transceiver 300 and/or the transceiver 330 can include (but is not limited to) a digital signal processer (DSP), modulator and/or demodulator, a digital-to-analog converter (DAC) and/or an analog-to-digital converter (ADC), and/or a frequency converter (including mixers, local oscillators, and filters) that can be utilized in transmitting and/or receiving of wireless communications. Further, those skilled in the relevant art(s) will recognize that antenna 335 and/or antenna 345 may include an integer array of antennas, and that the antennas may be capable of both transmitting and receiving wireless communication signals.

The controller 340 can include processor circuity 350 that is configured to control the overall operation of the mobile device 140, such as the operation of the transceiver 300—including, for example, transmitting and/or receiving of wireless communications via the transceiver 300, and/or perform one or more baseband processing functions (e.g., media access control (MAC), encoding/decoding, modulation/demodulation, data symbol mapping, error correction, etc.); the running of one or more applications and/or operating systems; power management (e.g., battery control and monitoring); display settings; volume control; and/or user interactions via one or more user interfaces (e.g., keyboard, touchscreen display, microphone, speaker, etc.). In an exemplary aspect, the controller 340 can be configured to control the transceivers 300 and/or 330 using the aggregated wireless driver as described below.

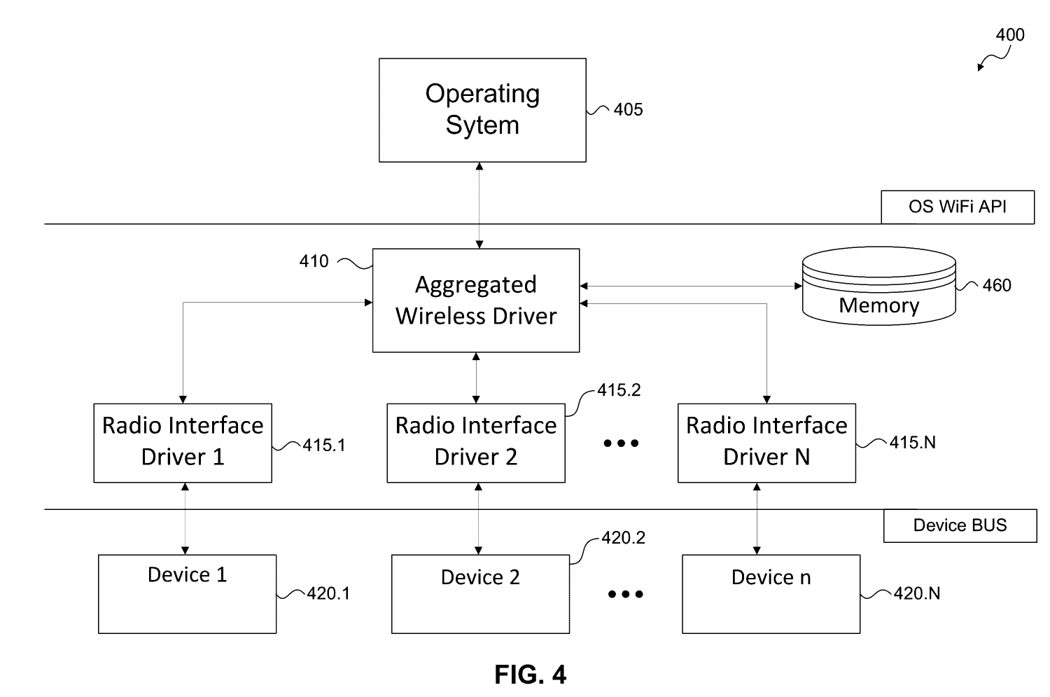

The controller 340 can further include a memory 360 that stores data and/or instructions, where when the instructions are executed by the processor circuitry 350, controls the processor circuitry 350 to perform the functions described herein. The memory 360 can be any well-known volatile and/or non-volatile memory, and can be non-removable, removable, or a combination of both. In an exemplary aspect, the memory 360 can store one or more aggregated wireless drivers as discussed in more detail below with reference to FIG. 4.

FIG. 4 illustrates a communication system architecture 400 according to an exemplary aspect of the present disclosure. In exemplary aspects, the communication system architecture 400 is implemented on and/or by the mobile device 140 and/or base stations 120.

The communication system architecture 400 can include an operating system 405 configured to communicate with one or more devices 420 (e.g., transceivers 300, 330) via an aggregated wireless driver (AWD) 410 and a corresponding one of the radio interface drivers (RIDs) 415. For example, the operating system 405 can communicate with device 420.1 via a corresponding radio interface driver 415.1 and device 420.2 via a corresponding radio interface driver 415.2, where the radio interface drivers 415.1 and 415.2 communicate with the operating system 405 via the AWD 410.

The devices 420 can include processor circuitry configured to interface, communicate and/or interact with, for example, one or more remote devices, remote networks, remote entities. In an exemplary aspect, the devices 420 can be network interface devices, including, for example, Wi-Fi network interface devices (e.g., a Wi-Fi network card, Wi-Fi transceiver 300), a WiGig network interface device (e.g., WiGig network card, WiGig transceiver 330), and/or other network interface devices as would be understood by one or ordinary skill in the relevant arts. The devices 420 are not limited to network interface devices and can be other input/output devices (e.g., video cards, storage (RAID) cards, keyboards, etc.) as would be understood by those skilled in the arts.

In an exemplary aspect, the aggregated wireless driver (AWD) 410 includes one or more computer programs and/or code configured to facilitate communications between the operating system 405 (and/or one or more applications running on the operating system 405) and one of more of the devices 420.

The AWD 410 can be configured to provide an aggregated interface between the operating system 405 and a plurality of the devices 420 to enable the operating system 405 to access hardware functions associated with the respective device 420. For example, the AWD 410 can include knowledge of two or more of the devices 420.1 to 420.N, which allows the operating system 405 and/or other computer programs associated with the operating system 405 to control and/or use the devices 420.

In an exemplary aspect, the device 420.1 can be a Wi-Fi network interface device configured to transmit and/or receive communications conforming to one or more of IEEE's 802.11 Wi-Fi protocols and device 420.2 can be a WiGig network interface device configured to transmit and/or receive communications conforming to IEEE's 802.11ad WiGig protocol, but the devices 420.1 and 420.2 are not limited to these protocols.

The AWD 410 can be configured to control the functionality of the plurality of network devices 420, and can interact with the operating system 405, including, for example, forwarding operating system requests to corresponding Radio Interface Drivers (RIDs) 415, coordinating and synchronizing activities between RIDs 415, and aggregating indications arriving from the RIDs 415 into single indication which can then be passed to the operating system 405.

The Radio Interface Drivers (RIDs) 415 includes one or more computer programs and/or code configured as an interface between the AWD 410 and a corresponding device 420. The RID 415 can be configured to control the corresponding device 420, including, for example, enabling hardware initialization of the device 420, facilitate handling of protocol specific functions, and/or facilitate driver specific implementations associated with the device 420. In an exemplary aspect, unlike typical drivers, the RIDs 415 are configured such that the operating system 405 will not recognize the RIDs 415 as a specific driver (e.g., as a specific network driver). That is, the RIDs 415 can be configured to avoid being recognized by the operating system 405 as a specific driver (e.g., a specific device driver). In operation, the RIDs 415 interact with the operating system 405 through the AWD 410, which establishes the recognition with the operating system 405. In this example, the non-recognition of the RID 415 will prevent the operating system 405 from being associated with two driver-related entities—the RID 415 and the AWD 410—which can lead to competing communications at the operating system 405. Rather, the operating system 405 interacts with the AWD 410, which services multiple RIDs 415 and corresponding devices 420.

In an exemplary aspect, the AWD 410 can provide a single interface with the operating system 405 by presenting itself as a single device driver (e.g., an 802.11 Wi-Fi driver). The AWD 410 can provide a Wi-Fi application programming interface (API) and interact with Wi-Fi services of the operating system 405.

The AWD 405 can be configured to generate and use a unique Media Access Control

(MAC) address to be used by operating system 405 for transmitting and receiving operations. In an exemplary aspect, the AWD 405 can adopt the MAC address of one of the devices 420 as its own MAC address. In other exemplary aspects, the MAC address generated and used by the AWD 405 can be different from those MAC addresses associated with the devices 420.

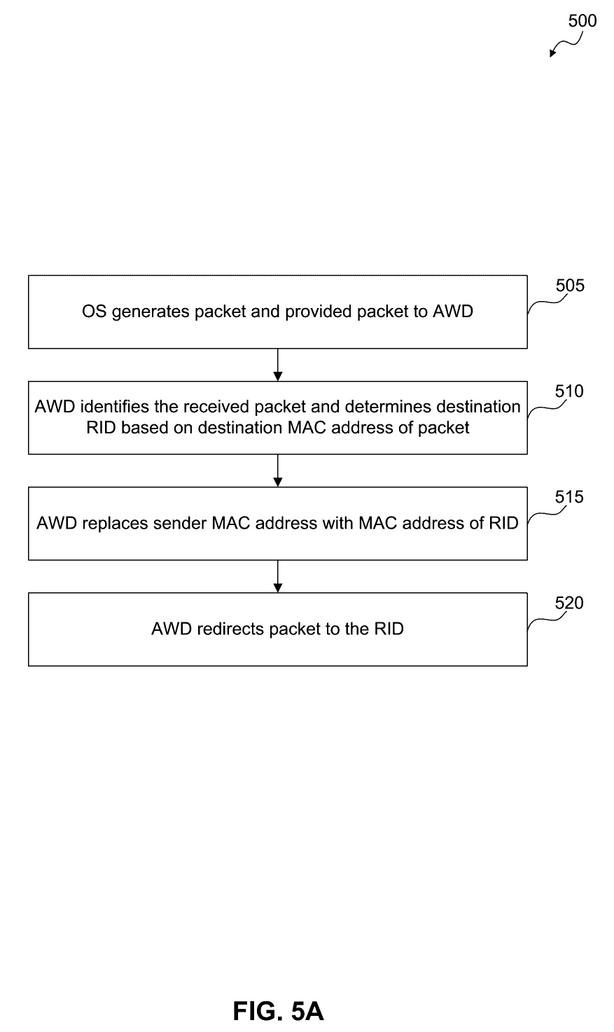

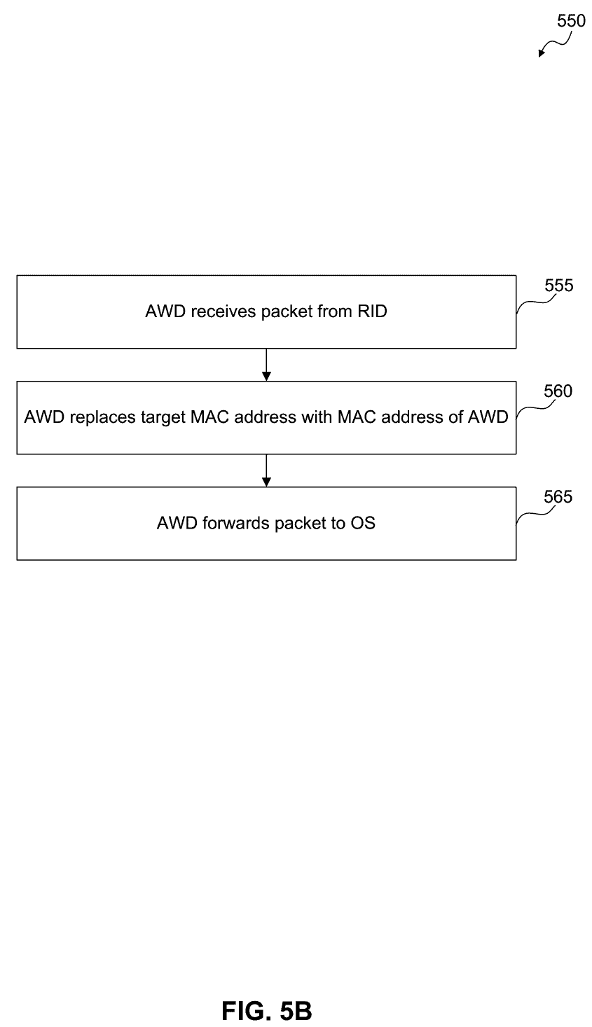

In operation, the AWD 410 can be configured to identify and record other wireless devices communicating with and/or in range of, for example, the mobile device 140. The AWD 410 can also record which RID 415 handles the communications with the various other wireless devices. With reference to FIG. 5, during a transmission operation 500, the operating system 405 can generate and provide a packet to the AWD 410 (step 505). The AWD 410 can identify the received packet and determine the destination RID 415 based on the destination MAC address associated with the packet (step 510). The AWD 410 can then be configured to replace the sender MAC address with the MAC address of the appropriate RID 415 (step 515), and redirect the packet to this RID 415 (step 520). With reference to FIG. 5B, during a reception operation 550, the AWD 410 can be configured to receive a packet from an RID 415 (step 555). The AWD 410 can then replace the target MAC address with its own MAC address (step 560) before forwarding the packet onto the operating system 405 (step 565).

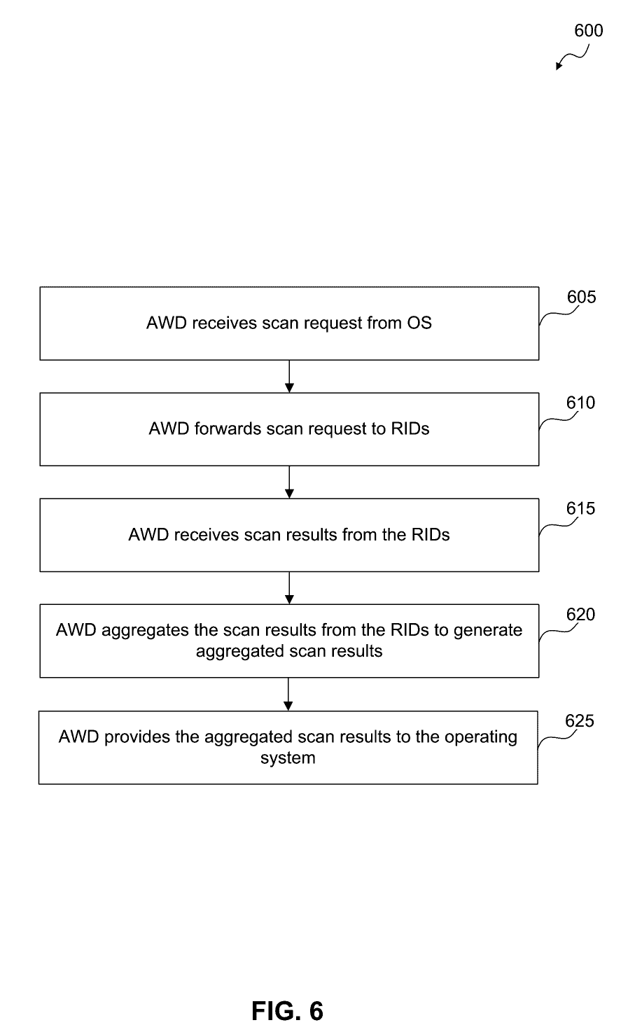

FIG. 6 illustrates a discovery method 600 according to an exemplary aspect of the present disclosure. In operation, the operating system 405 generates and sends a scan request to the AWD 410 (step 605). Upon receipt of the scan request, the AWD 410 can forward the scan request to RIDs 415 associated with available devices 420 (step 610).

After the respective scans by the devices 420 associated with the RIDs 415, the AWD 410 can receive the respective scan results from the RIDs 415 (step 615). In this example, the RIDs 415 can generate the scan results and provide their corresponding results to the AWD 410. The AWD 410 can store the scan results in memory 460.

The AWD 410 can then aggregate the results from the various RIDs 415 (step 620), and then provide the aggregated scan results to the operating system 405 (step 625). In this example, the aggregated scan results can mask devices using non-requested protocols, or can identify the devices based on their corresponding protocol if the operating system 405 is aware of the AWD's 410 aggregated functionality.

For example, if the operating system 405 request a scan by the device 420.1 (e.g., Wi-Fi network interface device), the AWD 410 can forward the scan request to device 420.1 and also to device 420.2 (e.g., WiGig network interface device). In this example, the AWD 410 can offer the operating system 405 the opportunity to establish communications using the protocol of the device 420.2 for increased performance, if available. That is, although the operating system 405 requested a Wi-Fi scan, the AWD 410 can provide the operating system 405 with discovered Wi-Fi devices as well as WiGig devices discovered during the scan by device 420.2. In providing the additional discovered WiGig devices, the AWD 405 can be configured to mask the WiGig devices as Wi-Fi devices. In this example, the operating system 405 can be unaware that the AWD 410 serves as an aggregated driver, and from an operational point of view, the operating system 405 would believe it is interacting with conventional device-specific drivers. If the operating system 405 selected one of the WiGig devices masked as a Wi-Fi device, the AWD 410 can be configured to facilitate the communication between the operating system 405 and device 420.2, with the operating system 405 believing it is communicating with a Wi-Fi device.

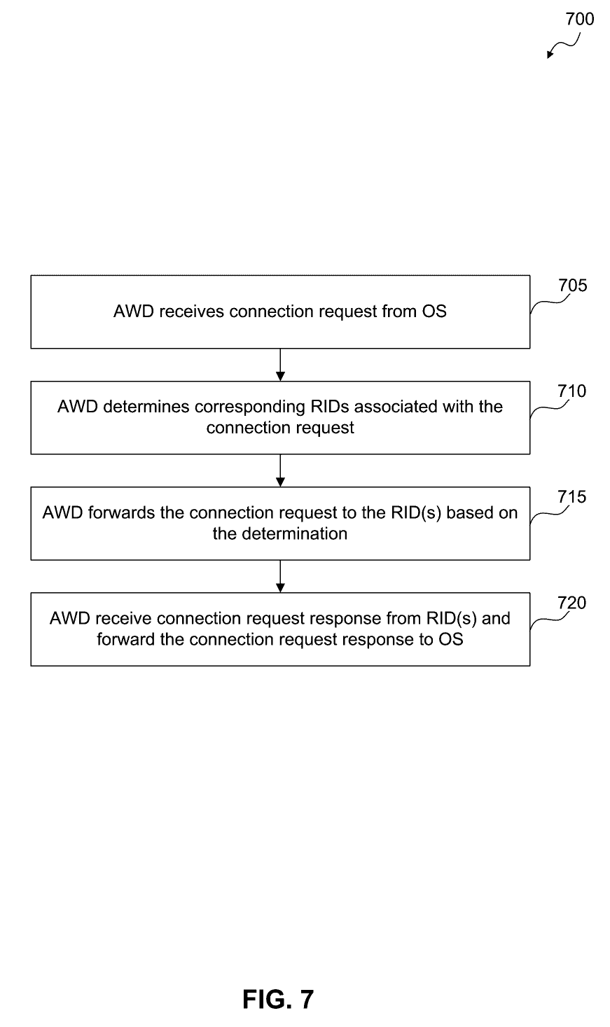

FIG. 7 illustrates a connection method 700 according to an exemplary aspect of the present disclosure.

In operation, the AWD 410 can receive a request from the operating system 405 to connect to a specific peer (e.g., a device discovered in a scan) (step 705). The AWD 410 can determine which RID 415 corresponds to the device 420 and the associated protocol that is configured to connect to the peer (step 710). The AWD 410 can forward the connection request to the RID 415 based on the determination (step 715). In an exemplary aspect, the AWD 410 can forward the request to two or more RIDs 415 if the selected peer includes multi-protocol capabilities, where the two or more RIDs 415 are associated with such protocols.

The AWD 410 can receive a connection request response from the RID(s) 415 and forward the response to the operating system 405 (step 720). In exemplary aspects where the connection request was forwarded to two or more RIDs 415, the AWD 410 can be configured to aggregate the two received responses and forward an aggregated response to the operating system 405.

In an exemplary aspect, the AWD 410 can be configured to perform power management operations. For example, the AWD 410 can be configured to receive one or more power management notifications from the operating system 405. Based on the received notifications, the AWD 410 can be configured to selectively designate one or more devices 420 as operative devices. In this example, devices 420 not designated to as operative devices can enter a power saving mode (e.g. a reduced power consumption mode) or can be powered off. The AWD 410 can be configured to control one or more of the non-designated devices 420 to enter the power saving mode.

In other exemplary aspects, the AWD 410 can be configured to coordinate other system operations, including (but not limited to), for example, initialization and shutdown of RIDs 415 and corresponding devices 420, negotiation of device capabilities of the devices 420 with the operating system 405, device power management of the devices 420, and/or other operations as would be understood by those skilled in the relevant arts.

In an exemplary aspect, the AWD 410 can be configured to control roaming operations between protocols of the corresponding devices 420. For example, the AWD 410 can be configured to control the roaming operations based on one or more characteristics of the device (e.g., mobile device 140) implementing the AWD 410. In an exemplary aspect, the AWD 410 can be configured to control the roaming operations based on the movement and/or location of the mobile device 140. For example, if the operating system 405 has established a connection to a WiGig network (e.g., via device 420.2), the movement of the mobile device 140 can result in increased roaming operations by the operating system 405 for the WiGig protocol as a result of range limits of the WiGig protocol (e.g., 10 meters).

The AWD 410 can be configured to determine the movement and/or location of the mobile device 140, and establish a connection on another protocol (e.g., Wi-Fi) having a larger range limit based on the movement/location determination. For example, the AWD 410 be configured to roam from a first protocol (e.g., WiGig) to a second protocol (e.g., Wi-Fi) based on the movement and/or location) of an associated device. In this example, the AWD 410 can roam onto a network corresponding to the second protocol if the AWD 410 determines that the associated device is currently moving. In operation, the AWD 410 can remain on the roamed network (e.g., Wi-Fi) until the AWD 410 determines that the associated device has stopped or motion has decreased to a determined quantity. Once stopped or at a reduced motion, the AWD 410 can roam onto the a network associated with the first protocol. For example, the AWD 410 can be configured to establish a connection using the WiGig protocol. If the AWD 410 determines motion, the AWD 410 can roam onto a network using the Wi-Fi protocol. Once determined that the motion has stopped, the AWD 410 can roam to a connection using the WiGig protocol. This procedure will reduce the frequency of roaming between WiGig networks due to the motion of the device and the limited range of the WiGig protocol while maintaining a more constant/stable connection using the Wi-Fi protocol during such movement.

### EXAMPLES

Example 1 is a communication device, comprising: a plurality of interface devices respectively configured to communicate with one or more other communication devices using a plurality of communication protocols; and a memory storing: a plurality of radio interface drivers (RIDs) respectively associated with the plurality of interface devices; and an aggregated wireless driver (AWD) forming an interface between an operating system (OS) of the communication device and the plurality of RIDs.

In Example 2, the subject matter of Example 1, further comprising processor circuity coupled to the memory, the processor circuitry being configured to control the plurality of interface devices based on one or more commands generated by the AWD.

In Example 3, the subject matter of Example 1, wherein the AWD is configured to aggregate communications from the plurality of RIDs to generate an aggregated communication, and to provide the aggregated communication to the OS.

In Example 4, the subject matter of Example 1, wherein the plurality of RIDs are configured to avoid being recognizable to the OS as a device driver associated with the plurality of interface devices.

In Example 5, the subject matter of Example 1, wherein the AWD is configured to broadcast a communication received from the OS intended for one of the plurality of RIDs to one or more other RIDs of the plurality of RIDs.

In Example 6, the subject matter of Example 1, wherein the AWD is configured to mask one or more characteristics of one or more of the plurality of interface devices from the OS.

In Example 7, the subject matter of Example 1, wherein the AWD is configured as a communication gateway between the OS and the plurality of interface devices.

In Example 8, the subject matter of Example 1, wherein the AWD is configured to control the communication device to roam from one of the plurality of communication protocols to another of the plurality of communication protocols based on one or more operational characteristics of the communication device.

Example 9 is a communication method of a communication device, comprising: associating a plurality of radio interface drivers (RIDs) with a plurality of interface devices; providing an aggregated wireless driver (AWD) as an interface between an operating system (OS) of the communication device and the plurality of RIDs; and processing, by the AWD, one or more communications between the OS and the plurality of RIDs, wherein the OS and the plurality of RIDs establish communications between each other via the AWD.

In Example 10, the subject matter of Example 9, wherein the processing of the one or more communications by the AWD comprises aggregating communications from the plurality of RIDs to generate an aggregated communication, and wherein the communication method further comprises providing the aggregated communication to the OS.

In Example 11, the subject matter of Example 9, wherein the processing of the one or more communications by the AWD comprises broadcasting a communication received from the OS intended for one of the plurality of RIDs to one or more other RIDs of the plurality of RIDs.

In Example 12, the subject matter of Example 9, wherein the processing of the one or more communications by the AWD comprises masking one or more characteristics of one or more of the plurality of interface devices from the OS.

In Example 13, the subject matter of Example 9, wherein the processing of the one or more communications by the AWD comprises: receiving, by the AWD, the one or more communications from the OS; determining one of the plurality of interface devices in which the one or more communications is intended; determining which one of the plurality of RIDs is associated with the intended interface device of the plurality of interface devices; providing the one or more communications to the determined one of the plurality of RIDs.

In Example 14, the subject matter of Example 13, wherein the processing of the one or more communications by the AWD further comprises providing the one or more communications to at least one other RID of the plurality of RIDs.

In Example 15, the subject matter of Example 9, wherein the processing of the one or more communications by the AWD comprises: receiving, by the AWD, a first communication from the a first RID of the plurality of RIDs; receiving, by the AWD, a second communication from the a second RID of the plurality of RIDs; generating an aggregated communication based on the first and the second RIDs; providing the aggregated communication to the OS.

Example 16 is a non-transitory computer-readable storage medium with an executable program stored thereon, wherein the program instructs a processor to perform the following method: associating a plurality of radio interface drivers (RIDs) with a plurality of interface devices; providing an aggregated wireless driver (AWD) as an interface between an operating system (OS) of a communication device and the plurality of RIDs; and processing, by the AWD, one or more communications between the OS and the plurality of RIDs, wherein the OS and the plurality of RIDs establish communications between each other via the AWD.

In Example 17, the subject matter of Example 16, the non-transitory computer-readable storage medium of claim 16, wherein the processing of the one or more communications by the AWD comprises: aggregating communications from the plurality of RIDs to generate an aggregated communication, and wherein the program instructs the processor to further provide the aggregated communication to the OS.

In Example 18, the subject matter of Example 16, wherein the processing of the one or more communications by the AWD comprises broadcasting a communication received from the OS intended for one of the plurality of RIDs to one or more other RIDs of the plurality of RIDs.

In Example 19, the subject matter of Example 16, wherein the processing of the one or more communications by the AWD comprises masking one or more characteristics of one or more of the plurality of interface devices from the OS.

In Example 20, the subject matter of any of Examples 9-12, wherein the processing of the one or more communications by the AWD comprises: receiving, by the AWD, the one or more communications from the OS; determining one of the plurality of interface devices in which the one or more communications is intended; determining which one of the plurality of RIDs is associated with the intended interface device of the plurality of interface devices; providing the one or more communications to the determined one of the plurality of RIDs.

In Example 21, the subject matter of Example 20, wherein the processing of the one or more communications by the AWD further comprises providing the one or more communications to at least one other RID of the plurality of RIDs.

In Example 22, the subject matter of any of Examples 9-12, wherein the processing of the one or more communications by the AWD comprises: receiving, by the AWD, a first communication from the a first RID of the plurality of RIDs; receiving, by the AWD, a second communication from the a second RID of the plurality of RIDs; generating an aggregated communication based on the first and the second RIDs; providing the aggregated communication to the OS.

Example 23 is an apparatus comprising means to perform the method as described in any of Examples 9-15.

Example 24 is a computer program product embodied on a computer-readable medium comprising program instructions, when executed, causes a machine to perform the method of any of Examples 9-15.

Example 25 is an apparatus substantially as shown and described.

Example 26 is a method substantially as shown and described.

### CONCLUSION

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processor circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

As will be apparent to a person of ordinary skill in the art based on the teachings herein, exemplary aspects are not limited to the 802.11 protocols (e.g., Wi-Fi and WiGig), and can be applied to other wireless protocols, including (but not limited to) Bluetooth, Near-field Communication (NFC) (ISO/IEC 18092), ZigBee (IEEE 802.15.4), Radio-frequency identification (RFID), and/or other wireless protocols as would be understood by one of ordinary skill in the relevant arts. Further, exemplary aspects are not limited to the above wireless protocols and can be used or implemented in one or more wired networks using one or more well-known wired specifications and/or protocols.

What is claimed is:

1. A communication device, comprising:
a plurality of interface devices respectively configured to communicate with one or more other communication devices using a plurality of communication protocols; and
a memory storing:
a plurality of radio interface drivers (RIDs) respectively associated with the plurality of interface devices; and
an aggregated wireless driver (AWD) forming an interface between an operating system (OS) of the communication device and the plurality of RIDs.

2. The communication device of claim 1, further comprising processor circuity coupled to the memory, the processor circuitry being configured to control the plurality of interface devices based on one or more commands generated by the AWD.

3. The communication device of claim 1, wherein the AWD is configured to aggregate communications from the plurality of RIDs to generate an aggregated communication, and to provide the aggregated communication to the OS.

4. The communication device of claim 1, wherein the plurality of RIDs are configured to avoid being recognizable to the OS as a device driver associated with the plurality of interface devices.

5. The communication device of claim 1, wherein the AWD is configured to broadcast a communication received from the OS intended for one of the plurality of RIDs to one or more other RIDs of the plurality of RIDs.

6. The communication device of claim 1, wherein the AWD is configured to mask one or more characteristics of one or more of the plurality of interface devices from the OS.

7. The communication device of claim 1, wherein the AWD is configured as a communication gateway between the OS and the plurality of interface devices.

8. The communication device of claim 1, wherein the AWD is configured to control the communication device to roam from one of the plurality of communication protocols to another of the plurality of communication protocols based on one or more operational characteristics of the communication device.

9. A communication method of a communication device, comprising:
associating a plurality of radio interface drivers (RIDs) with a plurality of interface devices;
providing an aggregated wireless driver (AWD) as an interface between an operating system (OS) of the communication device and the plurality of RIDs; and
processing, by the AWD, one or more communications between the OS and the plurality of RIDs, wherein the OS and the plurality of RIDs establish communications between each other via the AWD.

10. The communication method of claim 9, wherein the processing of the one or more communications by the AWD comprises aggregating communications from the plurality of RIDs to generate an aggregated communication, and
wherein the communication method further comprises providing the aggregated communication to the OS.

11. The communication method of claim 9, wherein the processing of the one or more communications by the AWD comprises broadcasting a communication received from the OS intended for one of the plurality of RIDs to one or more other RIDs of the plurality of RIDs.

12. The communication method of claim 9, wherein the processing of the one or more communications by the AWD comprises masking one or more characteristics of one or more of the plurality of interface devices from the OS.

13. The communication method of claim 9, wherein the processing of the one or more communications by the AWD comprises:
receiving, by the AWD, the one or more communications from the OS;
determining one of the plurality of interface devices in which the one or more communications is intended;
determining which one of the plurality of RIDs is associated with the intended interface device of the plurality of interface devices;
providing the one or more communications to the determined one of the plurality of RIDs.

14. The communication method of claim 13, wherein the processing of the one or more communications by the AWD further comprises providing the one or more communications to at least one other RID of the plurality of RIDs.

15. The communication method of claim 9, wherein the processing of the one or more communications by the AWD comprises:
receiving, by the AWD, a first communication from the a first RID of the plurality of RIDs;
receiving, by the AWD, a second communication from the a second RID of the plurality of RIDs;
generating an aggregated communication based on the first and the second RIDs;
providing the aggregated communication to the OS.

16. A non-transitory computer-readable storage medium with an executable program stored thereon, wherein the program instructs a processor to perform the following method:
associating a plurality of radio interface drivers (RIDs) with a plurality of interface devices;
providing an aggregated wireless driver (AWD) as an interface between an operating system (OS) of a communication device and the plurality of RIDs; and
processing, by the AWD, one or more communications between the OS and the plurality of RIDs, wherein the OS and the plurality of RIDs establish communications between each other via the AWD.

17. The non-transitory computer-readable storage medium of claim 16, wherein the processing of the one or more communications by the AWD comprises:
aggregating communications from the plurality of RIDs to generate an aggregated communication, and
wherein the program instructs the processor to further provide the aggregated communication to the OS.

18. The non-transitory computer-readable storage medium of claim 16, wherein the processing of the one or more communications by the AWD comprises broadcasting a communication received from the OS intended for one of the plurality of RIDs to one or more other RIDs of the plurality of RIDs.

19. The non-transitory computer-readable storage medium of claim 16, wherein the processing of the one or more communications by the AWD comprises masking one or more characteristics of one or more of the plurality of interface devices from the OS.
